(19) United States
(12) Patent Application Publication
(10) Pub. No.: US 2005/0025492 A1
(43) Pub. Date: Feb. 3, 2005

(54) System and method for eliminating effect of external interference on active tracking for free space optics communication

(75) Inventors: Alberto Marazzi, Milano (IT); Renato Milani, Lecco (IT); Giovanni Paoli, Merate (IT)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/900,154

(22) Filed: Jul. 28, 2004

(30) Foreign Application Priority Data
Jul. 29, 2003 (EP) 03 291878.1

(51) Int. Cl. H04B 10/00

(52) U.S. Cl. 398/131

(57) ABSTRACT

System and a method for eliminating external light interference effects in an active tracking equipment for free space optics communication, wherein a sample of an incoming light is received by a quad cells device (3) which outputs quadrant components of voltage values indicative of deviations of the incoming (IL; IL1) beam in different directions. The output of said quad cells device is filtered by a high pass filter (5) for blocking DC components as well as frequency components lower than a predetermined value from the out of the quad cells device (3), the output of the filter (5) being indicative of the position of incoming light (IL; IL1) with respect to the receiver (1).

### FIELD OF THE INVENTION

The present invention relates generally to electronic communications systems. More specifically, the present invention relates to communication systems which transmit and receive information signals that are carried by analog or digital modulation of laser light beams, including multiple wavelength transmission for example dense wavelength division multiplexing (DWDM).

The present invention is particularly, but not exclusively useful, for establishing a laser terrestrial communication link with active tracking to maintain the alignment between transmit and receive signals at the two far end terminals. Thus the invention relates in particular to a system and a method to implement an interference-free position sensing for the active alignment of a bidirectional free space optical communications system through atmosphere.

### BACKGROUND OF THE INVENTION

Free space optics in many applications requires active tracking to maintain the alignment between transmit and receive signals at the two far end transmitter and receiver terminals. In many cases the active tracking is obtained by using steering mirrors or by moving the whole receiver to a direction determined on the basis of the signals detected by a quad cells device. The quad cells device, is a multi-element detector of light well known in the related art. The operation of the quad cells is based on focusing or imaging an incoming light on to a detector area as a spot. The position or deviation of the spot is determined by comparing signals from four quadrants in the quad cells. Thus the quad cells provides an equal signal in all four quadrants for an aligned optical system. If any deviation is detected, the quad cells will then provide a feedback signal on corresponding mechanical actuators so that the position of the equipment is changed until the desired equilibrium is established again. The four signals detected corresponding to the four quadrants of the quad cells may be normally amplified as DC current.

The problem associated with this operation is that in practice there are interfering radiations present such as daylight or the solar radiation and under such conditions the device cannot correctly distinguish between the actual optical signal and the external interfering signal. As a result, the tracking system may misalign the transmitter-receiver.

A known solution for avoiding the interfering signals is that of using optical filtering on the system. However this solution suffers from the drawback that heavy filtering would be required which increases the complexity of the systel and the costs involved.

Another solution to the above problem is disclosed in PCT application with publication number WO 02/11298. This solution is based on modulated polarization of the signal. In this solution the signal carrying the information is also modulated by a sinusoidally varying polarization.

On the receiver side the detector of the main information is left insensitive to the polarization, whereas a polarization analyzer is placed on the portion of the received light directed to the quad cells which is usually separated from the main signal by means of a beam-splitter. This prior art solution uses a method to generate and detect a modulated polarization of the light, however such modulated polarization appears to be quite complicated.

It is therefore desired to provide a solution for eliminating the undesired effect of external interference on active tracking operations in free space optics communication that overcomes the above described drawbacks.

### DESCRIPTION OF THE INVENTION

The above objective is reached by using the solution proposed by the present invention which is based on the fact that external interfering signals do not substantially contain high frequency modulation components. Solar and day light, being some of the common interfering lights are basically continuous, albeit certain modulation produced by air scintillation, the main components of which are usually substantially lower than 1 kHz.

On the other hand, artificial lights may comprise components up to 1MHz for fluorescent lamps and only 50/60 Hz and few harmonics thereof for the incandescent lamps. However the intensity of these lights are normally negligible in an outdoor environment.

As it is known, an optical signal in a free-space optics systems carries information at high bit/rates, namely in the range of Mbit/s to Gbit/s and thus the basic components thereof are much higher in frequency than the interfering lights as described above.

Based on the above concept, the present invention proposes a system and a method in order to distinguish the desired signal from the undesired one by using the electronics available within the quad cells device itself. In this manner, no complex circuitry would be required. According to the solution herein proposed, and described in detail further below, the amplifiers of the quad diodes only amplify the higher frequency modulation components already present in the signal and will stop DC and lower frequencies.

Accordingly one object of the present invention is that of providing a system for eliminating external light interference effects in an active tracking equipment for free space optics communication, said system comprising a receiver for receiving an incoming light beam carrying an optical signal, said receiver being moveable in different directions in response to a position correction signal so as to align said receiver with the incoming light beam, the system further comprising a quad cells device for receiving a sample of said incoming light beam and outputting preferably four voltage value components of the received signal, characterized in that said quad cells device is connected to a high pass filter adapted for blocking DC components as well as frequency components lower than a predetermined value from the signals on each one of the said preferably four output components of the quad cells device, the output of the filter (5) being used for determining a position of the incoming light (IL; IL1) with respect to the receiver (1).

Preferably said predetermined frequency value is below about 1 kHz for blocking daylight interference or below about 1MHz for blocking fluorescent lamps interferences.

The high pass filter is preferably connected to a set of amplifiers for amplifying the filtered signals, said amplifiers being in turn connected to an automatic gain control loop adapted for being driven by a voltage obtained from the sum of output signals of the four amplifiers, said sum being indicative of information relative to differential values of said four components light as a function of the relative position of the incoming light beam received by said quad cells device, whereby said automatic gain control loop generates a control signal on the basis of the sum of the amplified signals received.

The sum of the four amplifiers outputs is equal to zero when the incoming light beam is received at the center of the quad cells device.

According to a preferred embodiment of the invention, the signals from the output of the amplifiers are fed to a set of drivers for driving a set of movement actuators adapted for moving said receiver in a desired direction as a response to a control signal produced by the automatic gain control loop.

Another object of the present invention is that if providing a method for eliminating external light interference effects in an active tracking equipment for free space optics communication, said method comprising the steps of:
receiving an incoming light beam carrying an optical signal by a receiver;
moving said receiver in different directions in response to a position correction signal so as to align said receiver with the incoming light beam;
receiving a sample of said incoming light beam by a quad cells device and outputting from said quad cells device preferably four voltage value components of the received signal; characterized by the further steps of:
blocking DC components as well as frequency components lower than a predetermined value from the optical signals on each one of the said preferably four output components of the quad cells device by means of a high pass filter connected at the output of said quad cells device, and using the output of the filter for determining a position of the incoming light with respect to the receiver.

These and further advantages of the present invention are explained in more detail in the following description as well as in the claims with the aid of the accompanying drawings.

### BRIEF DESCRIPTION OF THE DRAWINGS

FIG. 1 is a schematic representation of a conventional arrangement for splitting an incoming light beam between a light beam receiver and a quad cells device.

FIG. 2 is a block diagram of a system for eliminating external interference effects in an active tracking arrangement according to the invention.

### DESCRIPTION OF A PREFERRED EMBODIMENT

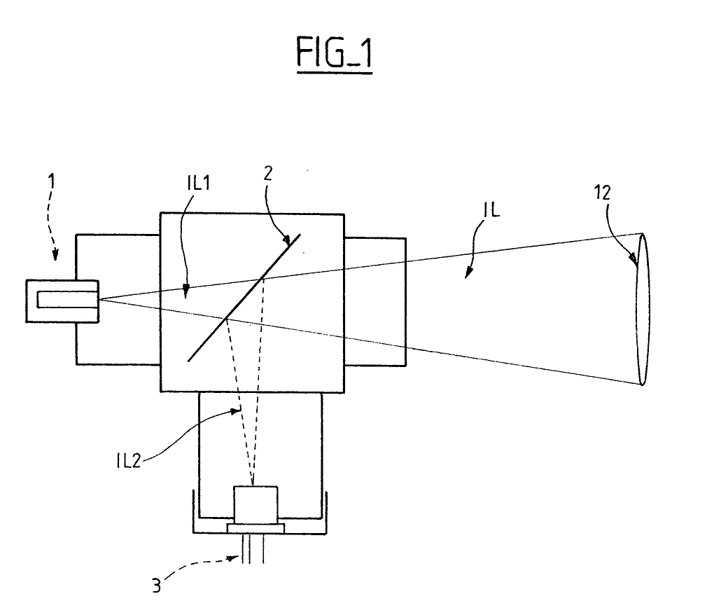

FIG. 1 represents a conventional arrangement at a receiver end of a light beam carrying an optical signal.

It is to be noted that the term “receiver” in this description refers to any apparatus that receives an optical signal, irrespective of its function at each end of a transmission link. Therefore, transmitters that could receive an optical signal, such as a return signal, for whatever reason are also to be understood to fall within the scope of the term “receiver” for the purpose of this description.

In a conventional arrangement as shown in FIG. 1, a splitter is placed on the path of the light beam that lets through a main portion of the incoming light beam and reflects a smaller portion thereof into a quad cells device so as to detect the position of the incoming light beam.

It is to be noted that the arrangement of FIG. 1 is only an example of such an arrangement and that any other known arrangements for optical splitting of the incoming light beam is also understood to be applicable within the scope of the present invention.

The receiver 1 usually comprises a telescope arrangement, however in the figure only a single lens 12 is shown for the sake of simplicity. Nevertheless, the receiver may also comprise any optical scheme such as for example, refractive, reflective or catadioptric, known by skilled persons in the related the art.

The converging incoming light beam IL encounters the splitter plate 2 that, by means of a proper coating of its surfaces, allows the major part of the signal IL1 to pass through and continue to be focalized on the main receiver device 1 which could be for example of the type using avalanche photodiodes (APD).

At the same time the splitter plate 2 reflects, preferably at 90°, a certain part of the signal IL2 to a quad cells device 3. The reflected portion IL2 is typically only in the range of 5-10% of the incoming beam IL so as to reduce the attenuation for the main receiver device 1 to the minimum value possible.

If the incoming light IL (and IL1) is not focused onto the center of the quad cells device 3, the four photodiodes incorporated in the quad cell device would then give different values of voltages generated at their respective outputs and these differential values can be amplified and used for determining the deviation of the incoming light IL and correcting the position of the receiver 1 by actuating certain driving means for performing the desired correction of the position as will be described in below.

The incoming light is modulated, for instance, by an On-Off Keying (OOK) signal. The frequency of the light carrying information is in the range of Mbit/s up to Gbit/s according the to the requirements of each particular transmission scheme.

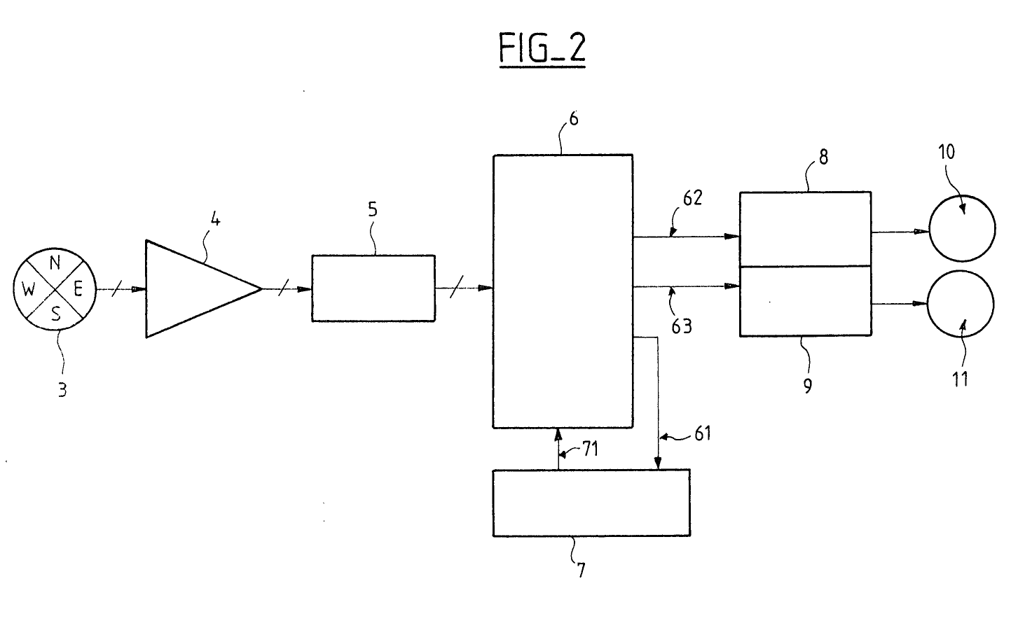

Referring now to FIG. 2, the quad cells device 3 is shown in conjunction to the rest of the circuitry necessary for detecting deviation and performing the correction of the receiver's position.

In FIG. 2, the four quadrants of the quad cells device 3 are generated by respective photodiodes shown by references N, S, E, W standing for north, south, east and west respectively. Each of these four quadrants represent a value relative to the deviation of the incoming light expressed in terms of voltages at the output of the photodiodes, which will be referred to also as differential values.

The output of the quad cells device 3, containing the four quadrant values, is fed into a low-noise amplifier 4 which is a conventional device in order to amplify the signals with a minimum the effect on the noise. Next the four quadrant values are fed into a high-pass filter 5. The filter 5 blocks all DC as well as all low frequency components of the optical signal and lets pass through, the higher frequencies which contain the useful information on the optical signal.

The range of frequencies to be blocked by the filter can be determined according to the requirements of each particular application. A preferred range comprises all frequency below about 1 kHz for blocking the daylight effect, and below or up to about 1MHz if it is desired to block interference from fluorescent lamps as well. All frequencies above these values are therefore allowed to pass through the filter.

The output of the filter 5 is fed into a stage shown in the figure by reference numeral 6 comprising a set of amplifiers and a set of envelop detectors for the four quadrants of the optical signal, namely N, S, E, W. The operation of the amplifiers and the envelop detectors are known in the related art and thus for the sake of simplicity a detailed description thereof is considered not necessary.

The four amplification chains within this stage are adapted to operate with AC components from a range of a few kHz up to the upper cut-off limit voltage of the diodes.

The output of the amplifiers, comprising four amplified differential values is fed into an automatic gain control (AGC) device 7 as shown by arrow 61. This is in fact a voltage for driving the AGC 7 and it consist of the sum of the four differential values relative to North-South and East-West. This voltage value is equal to zero only when the incoming light beam IL2 is directed to the center of the quad cells device 3.

Based on the value received at the input, the automatic gain control device 7 generates a response signal 71 containing information relative to the correction of the position of the receiver 1. This is done by feeding from the amplifier stage 6, the appropriate correction information signals 62 and 63 into driver devices 8 and 9 respectively as shown in FIG. 2. In this example these signals contain correction information for E-W components represented by arrow 62 and N-S component represented by arrow 63. However other combinations may be used without altering the scope of the present invention.

Finally the drivers 8 and 9 trigger respective actuator mechanisms 10 and 11 which move the receiver 1 in the desired directions in order to align the receiver 1 with the incoming light IL (IL1).

In practice, a positive input voltage in the drivers 8 and 9 could cause the drivers to move the respective actuator 10 and 11 in a first direction by means of any known mechanism such as for example steering mirrors, gimbals, etc.; and a negative input voltage in the drivers would cause them to move the respective actuator in a second direction opposite to the first direction. A zero voltage would cause no movement in the actuators.

In this manner a closed loop will be established between the position of the incoming light beam IL and its reflection spot on the quad cells device 3 on the one hand, and the movement of actuators on the other. No movement will occur if the light spot is received at the center of the receiver 1.

1. System for eliminating external light interference effects in an active tracking equipment for free space optics communication, said system comprising a receiver (1) for receiving an incoming light beam (IL; IL1) carrying an optical signal containing useful information as well as effects caused by interference radiations, said receiver being moveable in different directions in response to a position correction signal so as to align said receiver (1) with the incoming light beam (IL; IL1), the system further comprising a quad cells device (3) for receiving a sample of said incoming light beam and outputting voltage value components, preferably four, of the received signal, characterized in that said quad cells device (3) is connected to a high pass filter (5) adapted for blocking said interference radiation effects, the latter effects comprising DC components as well as frequency components lower than a predetermined value from the signals on each one of the, preferably four, output components of the quad cells device (3), the output of the filter (5) comprising substantially the useful information, being used for determining a position of the incoming light (IL; IL1) with respect to the receiver (1).

2. A system according to claim 1 wherein said predetermined frequency value is below about 1 kHz for blocking daylight interference effects or below about 1MHz for blocking fluorescent lamps interference effects.

3. A system according to claim 1 wherein said high pass filter (5) is connected to a set of amplifiers for amplifying the filtered signals, said amplifiers being in turn connected to an automatic gain control loop (7) adapted for being driven by a voltage obtained from the sum of output signals of the four amplifiers, said sum being indicative of information relative to differential values of said four components light as a function of the relative position of the incoming light beam (IL; IL1) received by said quad cells device (3), whereby said automatic gain control loop (7) generates a control signal (71) on the basis of the sum of the amplified signals received.

4. A system according to claim 3 wherein said sum of the four amplifiers outputs is equal to zero when the incoming light beam is received at the center of the quad cells device.

5. A system according to claim 3 wherein the signals from the output of the amplifiers are fed to a set of drivers for driving a set of movement actuators adapted for moving said receiver in a desired direction as a response to a control signal produced by the automatic gain control loop.

6. A method for eliminating external light interference effects in an active tracking equipment for free space optics communication, said method comprising the steps of:
receiving an incoming light beam (IL; IL1) carrying an optical signal by a receiver (1), the optical signal containing useful information as well as effects caused by interference radiations;
moving said receiver (1) in different directions in response to a position correction signal so as to align said receiver (1) with the incoming light beam (IL; IL1);
receiving a sample (IL2) of said incoming light beam by a quad cells device (3) and outputting from said quad cells device (3) voltage value components, preferably four, of the received signal; characterized by the further steps of:
blocking said interference radiation effects, the latter effects comprising DC components as well as frequency components lower than a predetermined value from the optical signals on each one of the preferably four output components of the quad cells device (3) by means of a high pass filter (5) connected at the output of said quad cells device (3), and using the output of the filter (5) comprising substantially the useful information, for determining a position of the incoming light (IL; IL1) with respect to the receiver (1).

7. A method according to claim 6 wherein said predetermined frequency value is below about 1 kHz for blocking daylight interference effects or below about 1MHz for blocking fluorescent lamps interference effects.

8. A method according to claim 6 wherein the filtered signals are amplified by a set of amplifiers, the resulting amplified signals being then summed (61) and fed to an automatic gain control loop (7), said sum (61) being indicative of information relative to differential values of said four components light as a function of the relative position of the incoming light beam (IL2) received by said quad cells device whereby said automatic gain control loop (7) generates a control signal (71) on the basis of the sum (61) of the amplified signals received.

9. A method according to claim 8 wherein said control signal produced by the automatic gain control loop (7) is fed, through said amplifiers to a set of drivers (8; 9), and said drivers drive a set of movement actuators (10; 11) that move said receiver (1) in a desired direction as a response to said control signal (71).
